(19) United States
(12) Patent Application Publication
(10) Pub. No.: US 2026/0326228 A1
(43) Pub. Date: Oct. 22, 2026

(54) RECEPTACLE ASSEMBLY

(71) Applicant: Lincoln Global, Inc., Cleveland, OH (US)

(72) Inventors: Eric G. Stewart, Girard, PA (US); Justin M. Makosky, Hiram, OH (US); James R. Kundmueller, Eastlake, OH (US)

(21) Appl. No.: 19/181,545

(22) Filed: Apr. 17, 2025

(51) Int. Cl. B23K 9/10

(52) U.S. Cl. CPC B23K 9/1006

(57) ABSTRACT

A receptacle assembly for a power source includes an insert with a first end and a second end. The first end defines a first opening communicating with a first receptacle, and the second end defines a second opening communicating with a second receptacle. The receptacle assembly also includes a receiver body defining a cavity configured to reversibly receive the insert in a first position granting access to the first receptacle and a second position granting access to the second receptacle.

The present disclosure generally relates to receptacles, and more specifically a welding receptacle assembly including a reversible insert with first and second ends respectively configured to receive cable connectors therein.

### BACKGROUND

Welding power sources generally include output terminals that establish an electrical connection between the power source, a workpiece, and an electrode holder, torch, or gun. One terminal defines a receptacle configured to mate with a connector affixed to an end of a weld cable, and the other output terminal defines a receptacle configured to mate with another connector affixed to an end of work lead. Many power sources include pre-existing receptacles designed for specific connector styles, e.g., a Tweco®, Twist-mate™ or Dinse™ connector style. This may be undesirable for the user since some weld cables and work leads may include a connector style that is incompatible with the receptacle. Additionally, some receptacles may degrade over time, affecting their ability to properly establish an electrical connection between the receptacle and the connector. It is desirable to provide a connector configured to alleviate the foregoing issues.

### SUMMARY

The following summary presents a simplified summary in order to provide a basic understanding of some aspects of the devices and assemblies described herein. This summary is not an extensive overview of the devices and assemblies described herein, and is not intended to identify critical elements or to delineate the scope of such devices or assemblies. Its sole purpose is to present some concepts in a simplified form as a prelude to the more detailed description that is presented later.

In accordance with one aspect, there is provided a receptacle assembly for a power source. The receptacle assembly includes an insert having a first end and a second end opposing the first end. The first end defines a first opening communicating with a first receptacle, and the second end defines a second opening communicating with a second receptacle. The receptacle assembly also includes a receiver body defining a cavity configured to reversibly receive the insert in a first position granting access to the first receptacle via the first opening and a second position granting access to the second receptacle via the second opening.

In an embodiment, the first receptacle is shaped and dimensioned to receive a first weld connector style, and the second receptacle is shaped and dimensioned to receive a second weld connector style.

In an embodiment, the first receptacle is shaped and dimensioned to receive a first weld connector style, and the second receptacle is shaped and dimensioned to receive the first weld connector style.

In an embodiment, the receptacle assembly also includes a retaining element configured to engage an outer surface of the insert to secure the insert in the receiver body.

In an embodiment, the receiver body defines an opening dimensioned to receive a fastener configured to engage the retaining element to urge the retaining element into engagement with the outer surface of the insert.

In an embodiment, the receptacle assembly also includes a pivot pin, and the retaining element defines an opening dimensioned to receive the pivot pin therethrough such that the retaining element may be pivoted into engagement with the insert to secure the insert in place.

In an embodiment, the receiver body defines a slot dimensioned to receive the retaining element therethrough when the retaining element is pivoted into engagement with the insert.

In an embodiment, the receiver body also includes an overmold adhered thereto. The overmold is configured to secure the receptacle assembly to a front panel of the power source.

In an embodiment, the receiver body includes a first end and a second end, and the cavity of the receiver body opens to the second end via a threaded opening. The threaded opening is configured to engage with a fastener to transmit current from an electrical component of the power source to the receiver body.

In an embodiment, the insert defines an outer surface that is at least partially threaded and configured to rotatably engage a retaining element to secure the insert to the receiver body.

In an embodiment, the receiver body defines an outer surface that is at least partially threaded and configured to rotatably engage a retaining element to secure the insert to the receiver body.

In accordance with another aspect, there is provided a welding power source including a front panel, an insert, and a receiver body. The receiver body is operatively connected to internal electrical circuitry of the power source. The receiver body defines a cavity configured to reversibly receive the insert in a first position granting access to the first receptacle and a second position granting access to the second receptacle.

In an embodiment, the first receptacle is shaped and dimensioned to receive a first weld connector style, and the second receptacle is shaped and dimensioned to receive a second weld connector style.

In an embodiment, the first receptacle is shaped and dimensioned to receive a first weld connector style, and the second receptacle is shaped and dimensioned to receive the first weld connector style.

In an embodiment, the power source also includes a retaining element configured to engage an outer surface of the insert to secure the insert in the receiver body.

In an embodiment, the receiver body defines an opening dimensioned to receive a fastener configured to engage the retaining element to urge the retaining element into engagement with the outer surface of the insert.

In an embodiment, the front panel defines an opening, and the receiver body includes an overmold thereon configured to secure the receiver body to the front panel.

In accordance with another aspect, a power source includes a front wall, a receiver body, and an insert. The receiver body is mounted to the front wall and defines a cavity. The reversible insert is configured to be mounted in the cavity in a first position and a second position. The reversible insert defines a first receptacle that is accessible when in the first position, and a second receptacle that is accessible when in the second position.

In an embodiment, first receptacle is configured to receive a first weld connector style and the second receptacle is configured to receive a second weld connector style.

In an embodiment, the power source also includes a retaining element configured to extend through an opening of the receiver body and engage the insert to secure the insert to the receiver body.

Numerous aspects of the general inventive concepts will become readily apparent from the following detailed description of exemplary embodiments, from the claims, and from the accompanying drawings.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a perspective view of an example arc welding system including a welding power source, an electrode holder, and a ground clamp operatively connected to the power source via a weld cable and a work lead;

FIG. 2 is a partial, perspective view of a front panel of a welding power source including an example receptacle assembly according to the present disclosure;

FIG. 3 is an exploded view of the receptacle assembly of FIG. 2;

FIG. 4A is a side section view the receptacle assembly of FIG. 2 in a disengaged state;

FIG. 4B is a side section view of the receptacle assembly of FIG. 2 in an engaged state;

FIG. 4C is a side section view of an example insert according to another embodiment;

FIG. 5 is a side section view of an example receptacle assembly according to another embodiment;

FIG. 6A is a side section view of another example receptacle assembly including an example retaining element according to an embodiment; and

FIG. 6B is a side section view of another example receptacle assembly including an example retaining element according to another embodiment.

### DETAILED DESCRIPTION

The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one,” “one or more,” and “and/or” are open-ended expressions that are both of including one of the terms, either of the terms, or both terms. For example conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities, the phrase “A or B” should be understood to include the possibilities of “A” or “B” or “A and B.”

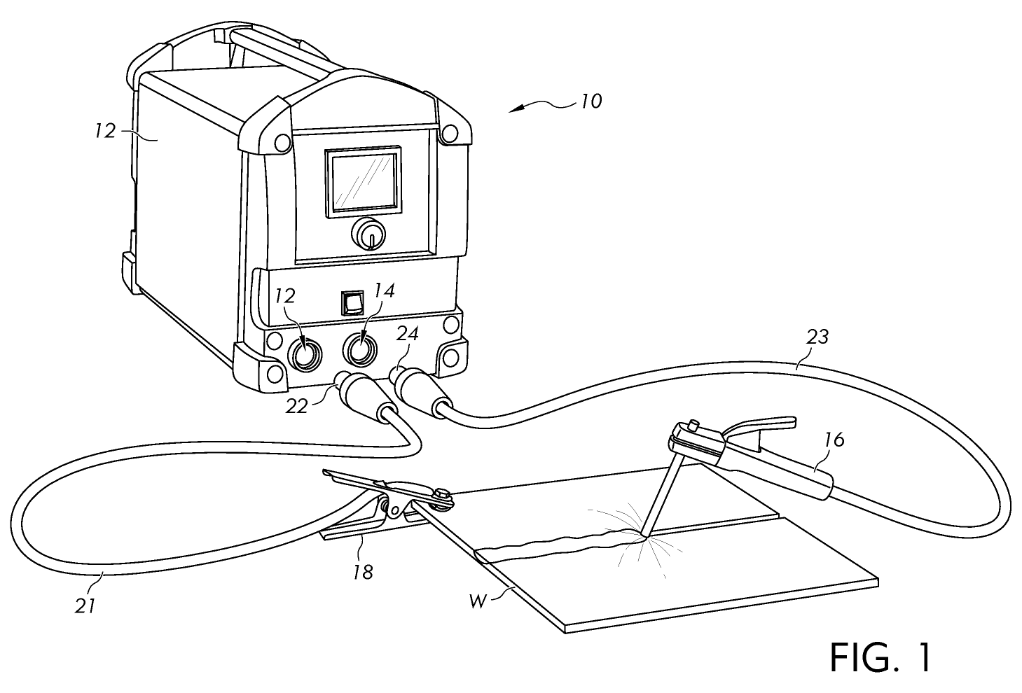

Referring to FIG. 1, an example arc welding system 10 is shown. In the illustrated example, the welding system 10 is depicted as being configured to perform shielded metal arc welding (SMAW). However, it should be understood that the various inventions described herein are applicable to other power sources configured to facilitate other processes, including, but not limited to, tungsten inert gas (TIG) welding, metal inert gas (MIG) welding, submerged arc welding (SAW), flux cored arc welding (FCAW), metal cored arc welding (MCAW), plasma welding, plasma cutting, or laser welding.

In the embodiment shown, the arc welding system 10 includes a first output receptacle 12 and a second output receptacle 14. The first output receptacle 12 is configured to receive a first connector 22 affixed to a work lead cable 21 (operatively connecting a ground clamp 18 to the power source 12), and the second output receptacle 14 is configured to receive a second connector 24 affixed to a weld cable 23 (operatively connecting an electrode holder 16 to the power source 12).

The first and second output receptacles 12 and 14 are configured to establish a secure electrical connection between the first and second connectors 22 and 24, respectively, to ensure efficient power transfer, minimize electrical resistance, and prevent overheating or energy loss during welding. For this purpose, the first and second connectors 22 and 24 may comprise mating features configured to engage mating features in the output receptacle. For example, the connector may comprise a self-locating guide or protrusion dimensioned to engage a slot or contoured recess in the output receptacle. In some embodiments, the connector may comprise clamp jaws configured to fit into the output receptacle such that the output receptacle urges the jaws into direct engagement with one another when received by the output receptacle. In other examples, the connector may include a tapered cam interface configured to engage a corresponding contoured interface in the output receptacle. For instance, in some embodiments, each output receptacle may be shaped and dimensioned to cooperate with a commercially known connector style such as a Tweco® style, Twist-mate™ st, a Dinse™, or other known twist-lock connector style.

Many welding power sources include output receptacles and that are configured to only accept only one connector style. This may be undesirable for the user, as some power sources (e.g., those supplied for field welding operations) may have an output receptacle that is incompatible with a weld cable or work lead connector style that is available at the job site. In view of such issues, some users utilize adapters to convert from one connector style to another connector style that is compatible with the output receptacle. However, such adapters may be easily lost or difficult to locate when performing field welding work.

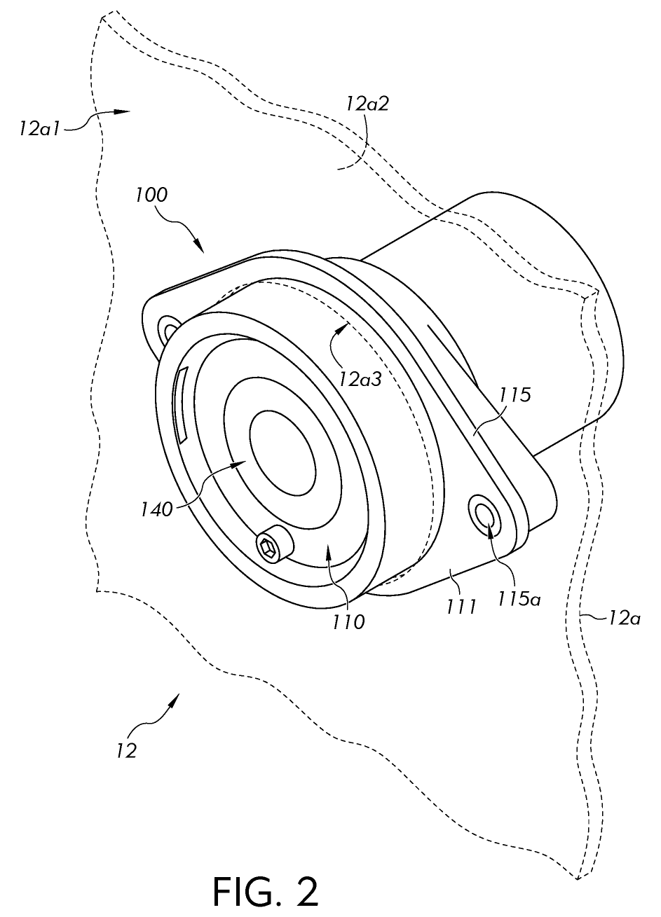

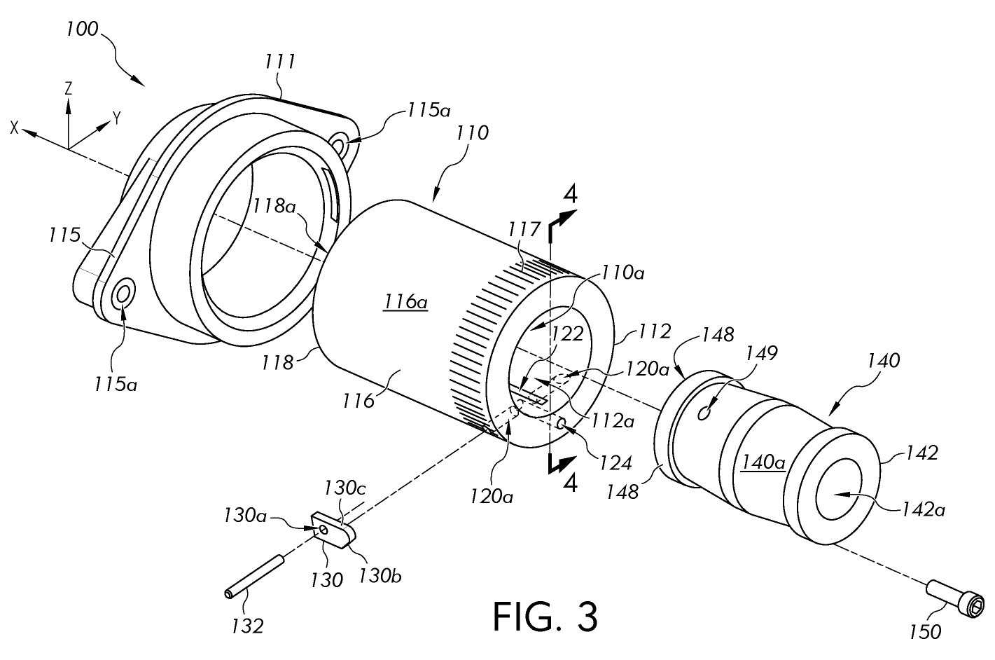

Referring now to FIGS. 2 and 3, an example receptacle assembly 100 according to the present disclosure is shown in relation to a front panel 12a of a power source 12. The power source 12 may embody, for example, a welding power source (e.g., a SMAW, GTAW, GMAW, FCAW, GTAW, SAW, etc.), a cutting power source (e.g., a plasma cutting power source), a laser welding power source, or a multi-process welding power source. As shown in FIG. 2, the front panel 12a may define a front or outer surface 12a1 (e.g., a user-facing surface) and a rear or inner surface 12a2 (facing internal electrical components or output circuitry of the power source). The front panel 12a may define an opening 12a3 dimensioned to receive the receptacle assembly 110 therethrough.

The receptacle assembly 100, in general, includes a receiver body 110 (i.e., a first part) and an insert 140 (i.e., a second part). The insert 140 may be reversibly received by the receiver body 110 in a first position to define a first receptacle or in a second position to define a second receptacle, as described below.

An overmold 111 may be adhered to an outer surface of the receiver body 110 (i.e., to the outer surface 116a (FIG. 3) of the wall 116 thereof) to secure the receiver body 110 to the opening 12a3 of the front panel 12a. In particular, the overmold 111 may include a flange 115 defining one or more openings 115a dimensioned to receive fasteners that are extended into corresponding openings of the front panel 12a, respectively, to secure the receiver body 110 to the front panel 12a. The overmold 111 may comprise a polymeric material (e.g., a suitable overmolded plastic) that is adhered to the outer surface 116a of the receiver body 110. In some embodiments, the outer surface 116a of the receiver body 110 may comprise a knurl 117 pattern (e.g., machined into the outer surface 116a) to enhance adhesion between the molten plastic material of the overmold 111 (e.g., during an injection molding process) and the receiver body 110, e.g., to affix or otherwise secure the overmold 111 thereto. In this manner, the overmold 111 may be considered to form part of the receiver body 110 (e.g., as an integral part thereof). In addition to securing the receiver body 110 to front panel 12a, the overmold 111 may also electrically insulate the receiver body 110 from the front panel 12a (e.g., by sandwiched between the front panel 12a and the receiver body 110 in the opening 12a3 (FIG. 2) of the front panel 12a).

Referring to FIG. 3, the receiver body 110 may include a first end 112 and a second end 118 opposing the first end 118 with a circumferential wall 116 extending therebetween. The wall 116 may circumscribe a cavity 110a extending along a longitudinal axis x of the receptacle assembly 100. The cavity 110a may open to the first end 112 via a first opening 112a and to the second end via a second opening 118a. In the embodiment shown, the receiver body 110 depicts a cylindrical shaped body. It is contemplated that the receiver body may take on other shapes and forms, for example, a square-shaped or rectangular-shaped body defining a cavity therein. In some embodiments, the receiver body 110 may be made of a rigid, electrically conductive material, for instance, a machined copper or brass material. In other embodiments, the receiver body 110 may be made from a sintered conductive metallic material.

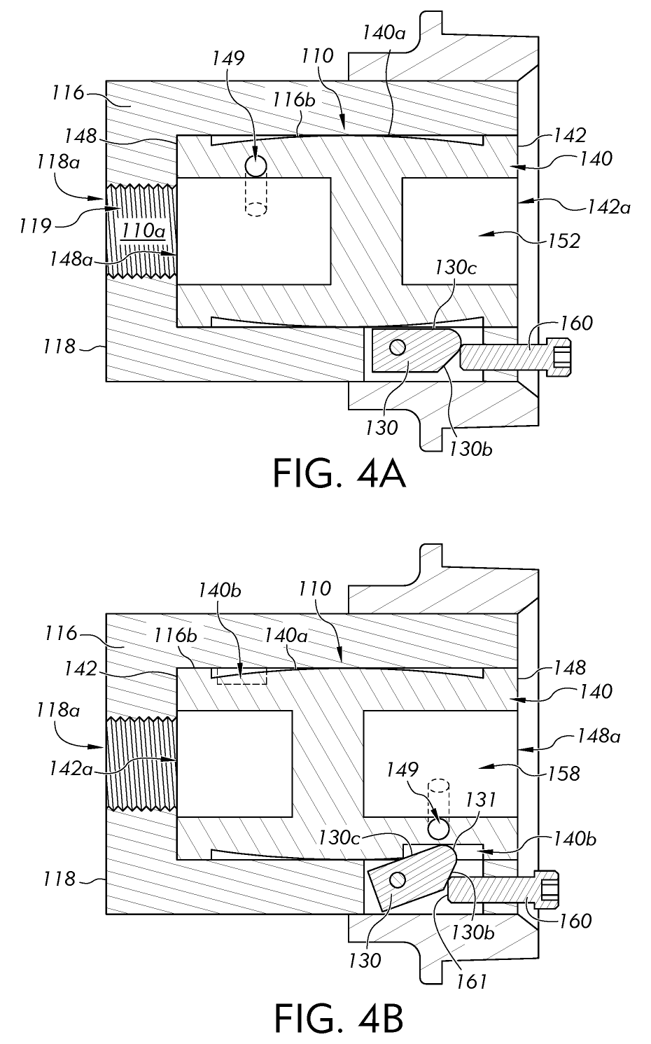

As shown in FIG. 4A, the second opening may define a thread pattern 119. The thread pattern 119 may be dimensioned and configured to engage with mating threads of a fastener (not shown) utilized to secure and operatively connect the receptacle assembly 100 to internal electrical circuitry of the power source, e.g., to supply/conduct current from the electrical circuitry to the receiver body 110 of the receptacle assembly 100. The internal electrical circuitry may comprise output circuitry, for example, an inverter board, a stepdown transformer, a choke or output rectifier, one or more bus bars or ring terminals, or any other known example of output circuitry for a power source.

Turning back to FIG. 3, one or more first openings 120a may extend between the cavity 110a and the outer surface 116a of the wall 116 in a direction substantially orthogonal to the longitudinal axis x. The openings 120a may be shaped and dimensioned to receive a pivot pin 132, as described below. A second opening 124 may extend into the first end 112 in a direction extending along the longitudinal axis x. The first openings 120a and the second opening 124 may open to an opening or slot 122 formed in the wall 116 of the receiver body 110 that extends in a direction substantially parallel to the longitudinal axis x. The slot 122 may be shaped and dimensioned to receive a retaining element 130 therein that is configured to secure the insert 140 to of the receiver body 110.

For this purpose, the retaining element 130 defines an opening 130a dimensioned to receive the pivot pin 132 therethrough such that the retaining element 130 may pivot from a first position (FIG. 4A) to a second position (FIG. 4B) when a fastener 160 is extended into the second opening 124, thereby urging a first end 131 of the retaining element 130 (FIG. 4B) upward based on engagement between the cammed surface 130b of the retaining element 130 and a distal end 151 of the fastener 160. In this manner, as the fastener 160 is extended into the opening 124, an engagement surface 130c of the retaining element 130 will be urged against an outer surface of the insert 140 to secure the insert 140 to the receiver body 110, e.g., to restrain the insert 140 from longitudinal movement. In some embodiments, it is contemplated that an outer surface of the insert 140 may also define a groove or opening 140b (shown demarcated via dashed lines in FIG. 4B) configured to receive the first end 131 of the retaining element 130 therein when the retaining element 130 is urged upward to secure the insert 140 to the receiver body 110.

When the insert 140 is secured to the receiver body 110, the receiver body 110 may conduct current to the insert 140 based on direct contact between an outer surface 140a of the insert 140 and an inner surface 116b of the wall 116 defining the cavity 110a (FIG. 3) of the receiver body 110.

As noted above, the insert 140 may be reversible mounted into or received by the cavity 110a of the receiver body 110 in either a first position (see, e.g., FIG. 4A) to define a first receptacle 152 or a second position (see, e.g., FIG. 4B) to define a second receptacle 158.

As shown in FIGS. 3, 4A and 4B, the insert 140 includes a first end 142 defining a first opening 142a (communicating with the first receptacle 152) and a second end 148 defining a second opening 148a (communicating with the second receptacle 158). In this manner, the insert 140 may be mounted in the receiver body 110 such that the first opening 142a faces a front of the power source to grant access to the first receptacle 152, or the insert 140 may be mounted in the receiver body 110 such that the second opening 148a faces a front of the power source to grant access to the second receptacle 158.

The first receptacle 152 may be configured to engage with a first connector style, for example, a first weld connector style, e.g., a Dinse™ or Twist-Mate™ style. And the second receptacle 158 may be configured to engage with a second connector style, for example, a second weld connector style, e.g., a Tweco™ connector style. Although it should be appreciated that the first and second receptacles 152 and 158 may be shaped and dimensioned to engage with the same connector style. For example, referring to the embodiment of FIG. 4C, an insert 140’ may include e first and second receptacles 152’ and 158’ that are symmetrically shaped and dimensioned to receive the same weld connector style (e.g., a Twist-Mate™ connector style or a Tweco™ connector style). This may be desirable if, for example, one of the first and second receptacles has degraded (based on wear), compromising the electrical connection between the receptacle and the connector.

Referring back to FIGS. 4A and 4B, in some embodiments, the first receptacle 152 may be configured to receive a smaller connector (configured for use for a certain amperage range, e.g., 80-150A), and the second receptacle 158 may be configured to receive a larger connector (configured for use with a higher amperage range, e.g., 150A and above). In such embodiments, the smaller connectors may be attached to smaller weld cables (e.g., a No. 8 cable size to a No. 4 cable size, and the larger connectors may be attached to larger weld cables (e.g., a No. 4 cable size to a 4/0 cable size. In further embodiments, the insert 140 may define an opening 149 dimensioned to receive a locking pin (not shown) of a connector, e.g., to secure the connector to the receptacle 158. In this manner, it should be understood that first and second receptacles 152 and 158 may be shaped and dimensioned to cooperate with a wide variety of different connectors (and connector styles thereof) that may be removable mounted therein/thereto.

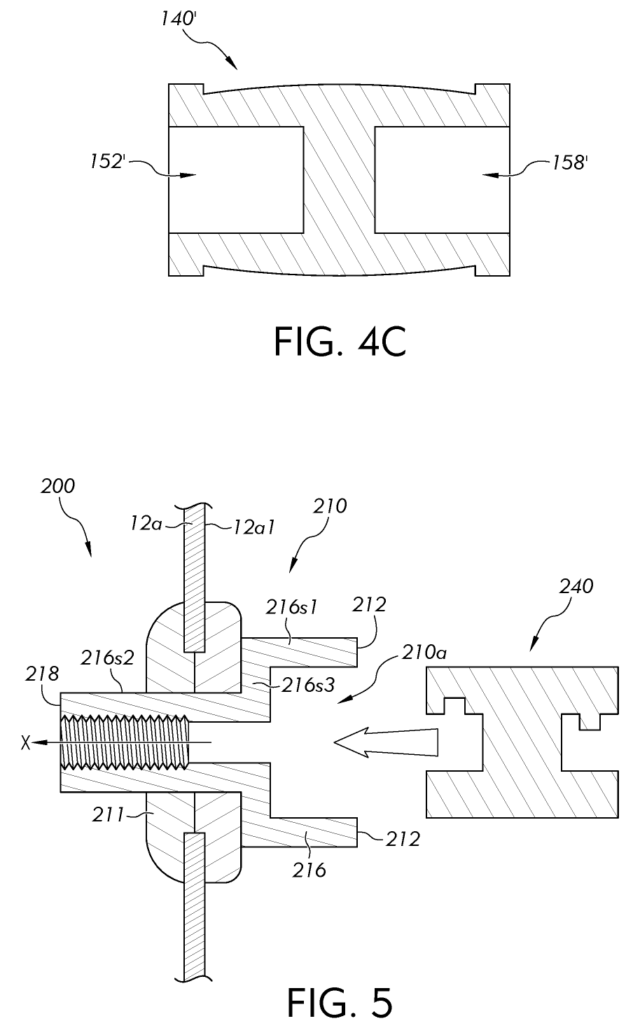

Turning now to FIG. 5, an example receptacle assembly 200 according to a second embodiment is shown in relation to the front panel 12a of the power source. The receptacle assembly 200 includes similar features to the receptacle assembly 100 of the first embodiment. Thus, a description of similar features has been omitted for brevity, except for the differences noted below.

In this embodiment, the receiver body 210 includes a wall 216 including a first segment 216s1 proximate to the first end 212 of the receiver body 210, a second segment 216s2 proximate to the second end 218 of the receiver body 210, and a third segment 216s3 connecting the first and second segments 216s1 and 216s2 and extending in a direction orthogonal to the longitudinal axis x of the receptacle assembly 200.

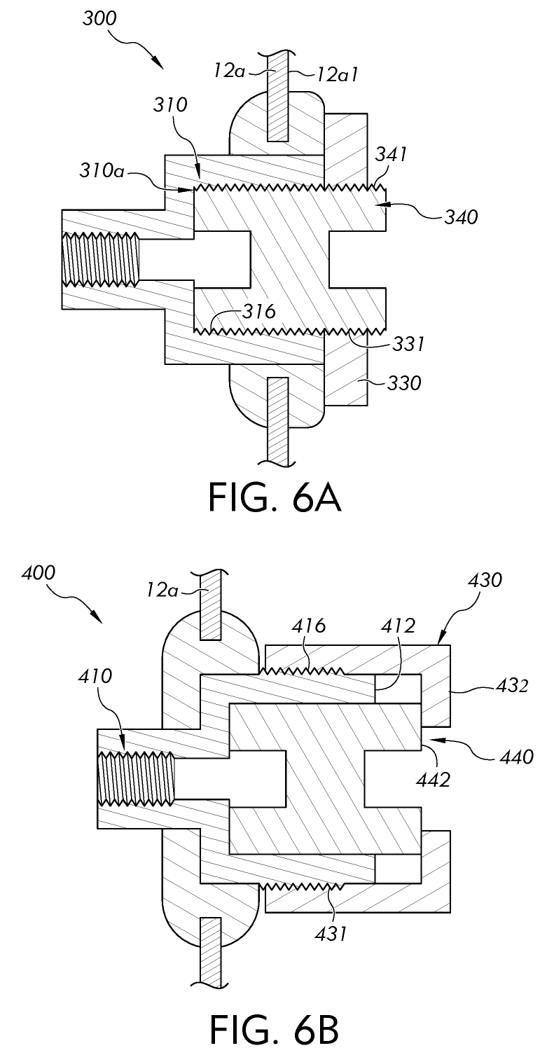

The first segment 216s1 defines a first diameter of the receiver body 210, and the second segment 216s2 defines a second diameter of the receiver body that is smaller than the first diameter. The first segment 216s1 and the third segment 216s3 at least partially define a cavity 210a of the receiver body 210 dimensioned to reversibly receive the insert 240 therein. In the embodiment shown, the cavity 210a is disposed outwardly relative to a front surface 12a1 of the front panel 12a, i.e., in a direction facing the insert 240 in the embodiment shown. It is contemplated that the cavity 210a may be disposed at least partially inwardly relative to the front surface 12a1 of the front panel 12a, for example, as shown in FIG. 6A. It is also contemplated that the first end 212 of the receiver body 210 may be substantially flush or entirely disposed inwardly relative to the front surface 12a1 of the front panel 12a.

As shown in FIG. 5, an overmold 211 is adhered to the receiver body 210 and sandwiched between the receiver body 210 and the front panel 12a, e.g., to affix the receiver body 210 to the front panel 12a and electrically insulate the front panel 12a from the receiver body 210. It is contemplated that the overmold 211 or another insulating material may be affixed to an outer surface of the first segment 216s1 of the wall 216.

Turning to FIG. 6A, another example of a receptacle assembly 300 is shown. In this embodiment, the insert 340 includes an outer surface defining a thread pattern 341 configured to rotatably engage a mating thread pattern 331 of a retaining element 330 configured to secure the insert 340 to the receiver body 310. In the embodiment shown, the retaining element 330 is a jam nut. Although it is contemplated that other examples of retaining elements 330 may be utilized to secure the insert 340 to the receiver body 310, for example, a lock nut, a toothed lock washer, a torque nut, a ratchet lock washer, cam-locking fasteners, torque limiting ratcheting nuts, and the like.

In some embodiments, the wall 316 of the receiver body 310 also defines an interior thread pattern configured to rotatably engage with the thread pattern 341 of the insert 340 to secure the insert 340 to the receiver body 310.

Turning to FIG. 6B, another example of a receptacle assembly 400 is shown. In this embodiment, an outer surface of the wall 416 of the receiver body 410 (proximate to the first end 412 thereof) may define a thread pattern configured to rotatably engage a mating thread pattern 431 of a retaining element 430 to secure the insert 440 to the receiver body 410. For instance, the retaining element 430 may embody a locking collar (bayonet type or thread on) comprising an inwardly extending leg 432 configured to engage an outwardly extending end 442 of the insert 440 to secure the inert 440 in place. Although it is contemplated that other forms of retaining elements 430 may be utilized, for instance, any suitable example of a retaining element 430 disclosed herein.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. §101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A receptacle assembly for a power source comprises:
an insert including a first end and a second end opposing the first end, wherein the first end defines a first opening communicating with a first receptacle, and the second end defines a second opening communicating with a second receptacle; and
a receiver body defining a cavity configured to reversibly receive the insert in a first position granting access to the first receptacle via the first opening and a second position granting access to the second receptacle via the second opening.

2. The receptacle assembly of claim 1, wherein the first receptacle is shaped and dimensioned to receive a first weld connector style, and the second receptacle is shaped and dimensioned to receive a second weld connector style.

3. The receptacle assembly of claim 1, wherein the first receptacle is shaped and dimensioned to receive a first weld connector style, and the second receptacle is shaped and dimensioned to receive the first weld connector style.

4. The receptacle assembly of claim 1 further comprising:
a retaining element configured to engage an outer surface of the insert to secure the insert in the receiver body.

5. The receptacle assembly of claim 4, wherein the receiver body defines an opening dimensioned to receive a fastener configured to engage the retaining element to urge the retaining element into engagement with the outer surface of the insert.

6. The receptacle assembly of claim 4, wherein the receptacle assembly further comprises a pivot pin, and the retaining element defines an opening dimensioned to receive the pivot pin therethrough such that the retaining element may be pivoted into engagement with the insert to secure the insert in place.

7. The receptacle assembly of claim 5, wherein the receiver body defines a slot dimensioned to receive the retaining element therethrough when the retaining element is pivoted into engagement with the insert.

8. The receptacle assembly of claim 1, wherein the receiver body further comprises an overmold adhered thereto, said overmold configured to secure the receptacle assembly to a front panel of the power source.

9. The receptacle assembly of claim 1, wherein the receiver body includes a first end and a second end, wherein the cavity of the receiver body opens to the second end via a threaded opening, wherein the threaded opening is configured to engage with a fastener to transmit current from an electrical component of the power source to the receiver body.

10. The receptacle assembly of claim 1, wherein the insert defines an outer surface, wherein the outer surface is at least partially threaded and configured to rotatably engage a retaining element to secure the insert to the receiver body.

11. The receptacle assembly of claim 1, wherein the receiver body defines an outer surface, wherein the outer surface is at least partially threaded and configured to rotatably engage a retaining element to secure the insert to the receiver body.

12. A welding power source comprises:
a front panel including a receiver body operatively connected to internal electrical circuitry of the power source, wherein the receiver body defines a cavity; and
an insert defining a first receptacle and a second receptacle, wherein the cavity of the receiver body is configured to reversibly receive the insert in a first position granting access to the first receptacle and a second position granting access to the second receptacle.

13. The welding power source of claim 12, wherein the first receptacle is shaped and dimensioned to receive a first weld connector style, and the second receptacle is shaped and dimensioned to receive a second weld connector style.

14. The welding power source of claim 12, wherein the first receptacle is shaped and dimensioned to receive a first weld connector style, and the second receptacle is shaped and dimensioned to receive the first weld connector style.

15. The welding power source of claim 12, wherein the power source further comprises a retaining element configured to engage an outer surface of the insert to secure the insert in the receiver body.

16. The welding power source of claim 12, wherein the receiver body defines an opening dimensioned to receive a fastener configured to engage the retaining element to urge the retaining element into engagement with the outer surface of the insert.

17. The welding power source of claim 12, wherein the front panel defines an opening, and the receiver body includes an overmold thereon configured to secure the receiver body to the front panel.

18. A power source comprises:
a front wall;
a receiver body mounted to the front wall, wherein the receiver body defines a cavity; and
a reversible insert configured to be mounted into the cavity in a first position and a second position, wherein the reversible insert defines a first receptacle that is accessible when in the first position, and a second receptacle that is accessible when in the second position.

19. The power source of claim 18, wherein the first receptacle is configured to receive a first weld connector style, and wherein the second receptacle is configured to receive a second weld connector style.

20. The power source of claim 18, wherein the power source further comprises:
a retaining element, wherein the retaining element is configured to extend through an opening of the receiver body and engage the insert to secure the insert to the receiver body.
